(19) United States
(12) Patent Application Publication
(10) Pub. No.: US 2006/0064348 A1
(43) Pub. Date: Mar. 23, 2006

(54) System and method for automatic presentation of locality-based content on network site

(75) Inventor: Li Li, Issaquah, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/947,337

(22) Filed: Sep. 23, 2004

(51) Int. Cl. G07G 1/14

(52) U.S. Cl. 705/14

(57) ABSTRACT

A system and related techniques automatically parse Web and other network sites, to determine whether the site contains content directed to local content or interests. The invention may then access a content database to retrieve ads or other media or content which match or correspond to the detected locality or region, such as ads for local or regional restaurants, car dealerships, physicians, sports or other services or products. The locality or region may be identified, for instance, by the presence of geographic clues or indicators in the general content of the Web site, for instance, the presence of ZIP codes, telephone numbers, town names or other semantic or other indicators which have some geographic connotation. Because the delivery of localized content according to the invention depends not on user input but on an examination of Web sites for these types of indicators, which examination may be performed by programmed agents, localized ads or other content may be automatically generated and delivered without user input or tracking. According to the invention in one regard, the user may therefore view ads and other content which may be akin to an online “yellow pages” experience, in which advertisements and other content are automatically grouped according to region or area.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of network services, and more particularly to a platform for automatically filtering and delivering locality-based advertisements or other media to Web or other networked sites which demonstrate a local nature or connection.

### BACKGROUND OF THE INVENTION

The advent of commercial paid advertisements and other media content has led to an increased desired for more highly targeted and effective marketing campaigns on the Internet. One general approach in presenting advertisements or other content to users consists of attempting to supply a user or groups of users with advertisements for businesses within some general geographic area of that user or users. Thus, a user who customizes a personal Web page may enter their postal ZIP code, telephone number or other identifying information which may permit that page to be encoded with local weather reports, news, traffic or other content, based on the corresponding location.

However, even Web pages or services which track user inputs to generate localized content still rely on detecting inputs or behavior in the user side. Because of that dependency, therefore, if a user chooses not to submit their ZIP code, telephone number or other identifying information, or if that information becomes corrupted or obsolete, it may not be possible to generate or deliver accurate localized ads or other content to the user. Other problems in localized media delivery exist.

### SUMMARY OF THE INVENTION

The invention overcoming these and other problems in the art relates in one regard to a system and method for automatic presentation of locality-based content, in which a Web or other network site may be automatically scanned or examined for the presence of geographic indicators, such as postal ZIP codes, telephone numbers, town or state names, or other indicators of locality or region. In embodiments, those Web sites may be examined by programmed agents to detect the presence of those types of indicators. When geographic indicators are found, those indicators may be transmitted to a selectable content server to interrogate a content database or other source of transmissible ads or other content. That geographically matched content may then be transmitted to the user's client or other device, to present within a set of selectable ad slots or other dynamically programmable fields or areas within the user interface. The user may thus view a set of automatically customized advertisements or other content based on the localized nature of the Web site itself, without a need to track user inputs or behavior. According to the invention in one regard, the user may therefore experience a sense of local “yellow pages” type advertising which is tailored to the region represented or served by that site.

### BRIEF DESCRIPTION OF THE DRAWINGS

FIG. 1 illustrates an architecture in which a system and method for automatic presentation of locality-based content may operate, according to embodiments of the invention.

FIG. 2 illustrates a user interface with selectable media content, according to embodiments of the invention.

FIG. 3 illustrates an ad table which may be used to serve content to Web or other sites, according to embodiments of the invention.

FIG. 4 illustrates a flowchart of overall locality-based content processing, according to embodiments of the invention.

### DETAILED DESCRIPTION OF EMBODIMENTS

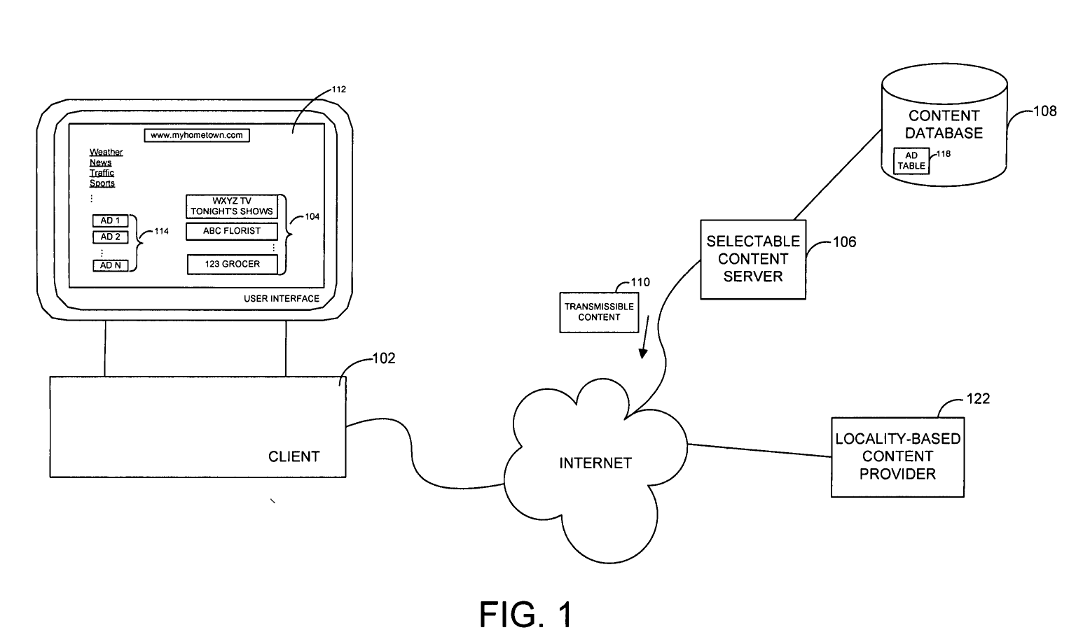

FIG. 1 illustrates an architecture in which a system and method for automatic generation of locality-based content for a network site may operate, according to embodiments of the invention. As illustrated in that figure, in embodiments a user may operate a client 102, such as a personal computer, network-equipped cellular telephone or other mobile device, or other client or machine using a user interface 112 such as a graphical user interface, to perform Web or Internet surfing, view, download or manipulate files or perform other tasks. In embodiments the user interface 112 may be, include or present an application such as a Web browser to permit a user to view Web, Internet or other network sites, such as intranet sites or other content. In embodiments, the Web browser or other application or interface may present the user with content and media including localized Web site content 104, such as a listing of television, radio or other media programming for a city, town or other location, an advertisement or promotion for goods or services such as grocery, restaurants, florists, car dealerships, real estate services, or other goods or services. The localized Web site content 104 may be transmitted to the client 102 for viewing via interface 112, for example, by a locality-based content provider 122 such as an Internet service provider (ISP), a media Web site such as a radio or television Web site, or other site location, operator or channel.

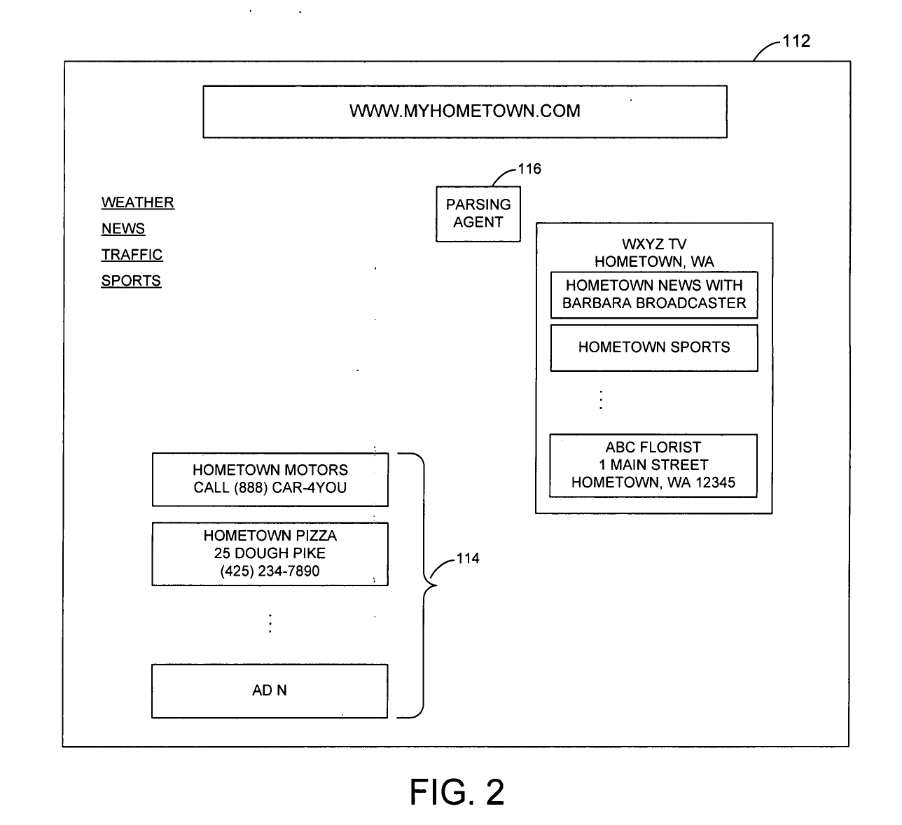

According to embodiments of the invention localized Web site content 104 may be detected, identified and examined for the presence of geographic indicators or identifiers. That is, the set of localized Web site content 104 may contain words, numbers or other semantic or other content which indicates or suggests the presence of locality-based or locality-related content or information. Those indicators may include for example the names of towns, cities or states, telephone numbers, addresses, television, radio station or other media outlet call signs or names, or other codes, fields or data which suggest that the content is directed or related to a certain or probable geographic location. According to embodiments of the invention, and as for example illustrated in FIG. 2, those indicators or identifiers may be detected using a parsing agent 116, which may be or include, for example, a Javascript™ or other code or programming to parse content such as, for example, the hyper text markup language (HTML) or extensible markup language (XML) code embedded in a Web site served or generated by locality-based content provider 122, or other source. According to embodiments of the invention in another regard, the potential locality indicators may also be captured by parsing agent 116 by other techniques including the detection of user behavior, such as the clicking of business name, telephone number or other links. Such user behavior may likewise in embodiments be captured and stored for future reference.

According to embodiments of the invention in a further regard, and as again illustrated in FIG. 1, when parsing agent 116 has detected and captured potential locality identifiers, that agent may communicate with a selectable content server 106 to process those identifiers for purposes of generating localized advertisements or other media or content. More specifically, the selectable content server 106 may receive potential locality identifiers from parsing agent 116 or other source and transmit those identifiers to a content database 108, which may be, include or interface to, for example, a relational database server or other database engine. The content database 108 may then run a query or interrogate an ad table 118 or other repository which may correlate or categorize identifiers such as captured ZIP code, area code or telephone number or other information with specific geographic areas, and in turn with a set of selectable advertisements or other portable or transmissible content which may be served to client 102 for display on user interface 112. In embodiments, identifiers may be for given Web sites or other sources may be categorized by location and/or stored or cached to content database 108 or other store, for instance based on universal resource locator (URL) or otherwise.

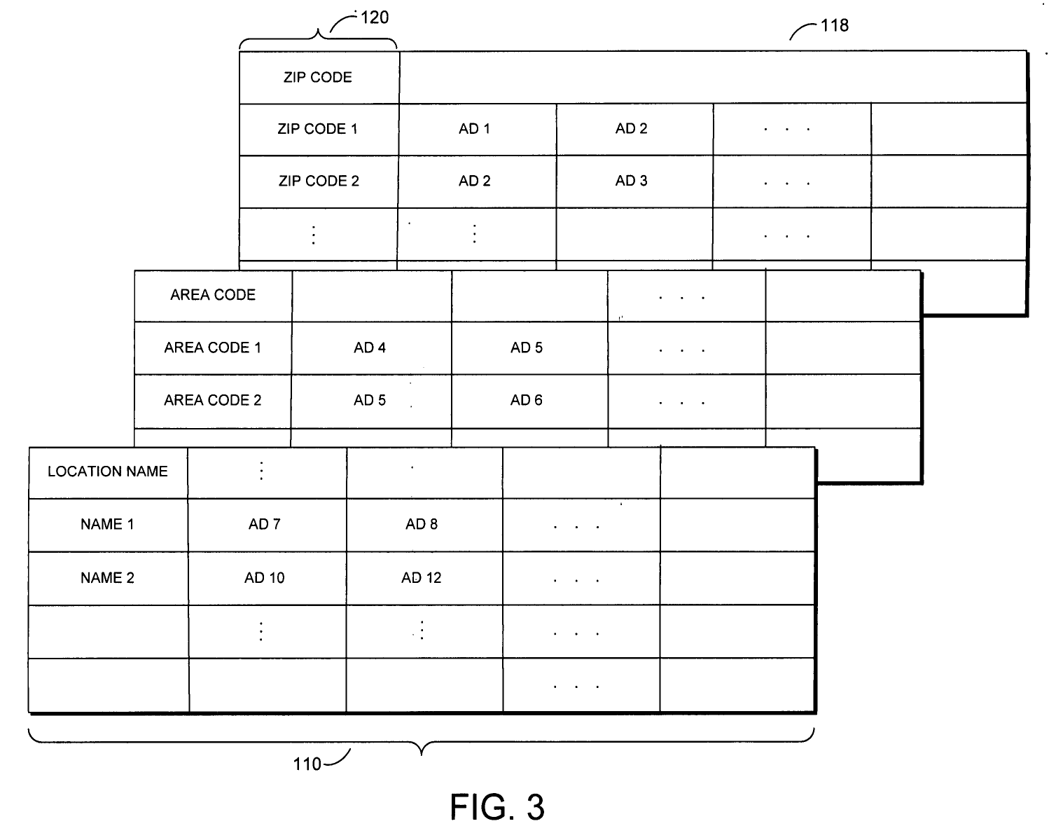

Thus, and for example as more specifically illustrated in FIG. 3, the content database 108 may correlate one or more locality identifiers 120 with selected items in a set of transmissible content 110, such as a set of stored advertisements, banners, audio or video clips, or other streaming or other media or content. In embodiments, the transmissible content 110 may be or include commercial advertisements, promotions or other content which is sponsored by or directed to companies, agencies or other advertisers located in or having a connection to a geographic area indicated by the one or more locality identifiers 120 specified for a given Web page or other source. According to embodiments of the invention in one regard, the sponsors or sources of the transmissible content 110 may participate in the delivery of content to location-matched sites by way of pair or other subscription to a network service or provider supporting that functionality. Other arrangements are possible. When appropriate advertisements or other transmissible content 110 is identified for the given location, the selectable content server 106 may transmit or serve that content, for instance directly to client 102, to locality-based content provider 122 for direction to client 102, or to other destinations.

The user of client 102 may thus receive ads or other transmissible content 110 which may be displayed in a set of selectable media sockets 114, such as predefined areas on a Web page or other structure or area within or presented by or in user interface 112. As again shown in FIG. 3, the transmissible content 110 presented in the set of selectable media sockets 114 may thus be matched to, and consistent with, the region or area served or supported by a given Web site or other source. The user may thus transparently be presented with content which is appropriate to the locality represented by or in that Web site or source, without a necessity for the user to input preferences for local ads or other content.

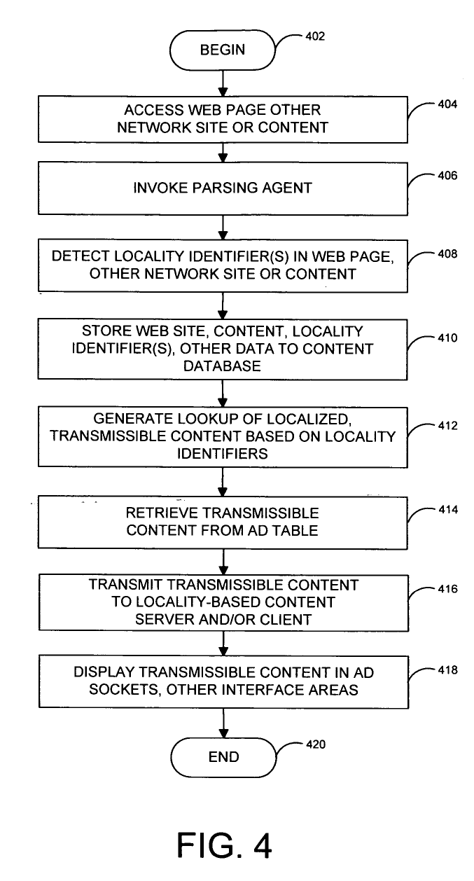

Overall locality detection and content processing is illustrated in FIG. 4. In step 402, processing may begin. In step 404, a Web site or other network site or content may be accessed to examine and discriminate the content of that site, for local or geographically indicated content. In step 406, parsing agent 116 such as a Java script application or other programmed agent or parser may be invoked. In step 408, locality identifiers or indicators may be detected in the Web site or other network site or content. Parsing agent 116 may in embodiments conduct that examination at regularly scheduled times, at off-peak times or other times or intervals.

In step 410, information identifying or constituting the Web site, such as a URL as well as its locality identifiers and other data may be stored to content database 108, or other storage or sites. In step 412, the locality indicators or identifiers extracted from the Web site may be used to perform a lookup against ad table 118 or other storage, to match the indicated locality to corresponding local ads or other content or media. In step 414, localized transmissible content may be retrieved from ad table 118 or other content or media stored in content database 108, or elsewhere. In step 416, the localized transmissible content 110 may be transmitted to a locality-based content provider 122, such as a Web server for a local radio, television or news station or other media outlet. In embodiments, the transmissible content 110 may also or instead be transmitted to client 102, directly.

In step 418, the transmissible content 110 may be displayed in the set of selectable content sockets 114 or otherwise in user interface 112, for instance in a set of structured HTML or XML ad slots in a Web browser or other application. In step 420, processing may repeat, return to a prior processing point, jump to a further processing point or end.

The foregoing description of the invention is illustrative, and modifications in configuration and implementation will occur to persons skilled in the art. For instance, while the invention has generally been described in terms of the examination of a Web site to determine the presence of locality-based content, in embodiments other network sites or sources may be scanned, such as intranet or other public or private networks or media. Likewise, while the invention has in some regards been described as involving the serving of transmissible local content received from advertisers participating in a paid-for or subscription based network service, in embodiments the transmissible localized ads or other content may be received from other sources, such as for example advertisers or others who do not participate or do not pay for their participation in a network or service.

Similarly, while the invention has in embodiments been described as delivering selectable or transmissible content from a single content database 108, in embodiments the local ads or other content delivered to the selectable media slots 114 may be delivered from multiple databases or other storage or sources. Other hardware, software or other resources described as singular may in embodiments be distributed, and similarly in embodiments resources described as distributed may be combined. The scope of the invention is accordingly intended to be limited only by the following claims.

What is claimed is:

1. A system for generating localized content for insertion into networked site content, comprising:
an input interface to receive a set of locality identifiers related to a location associated with a networked site; and
a selectable content server, the selectable content server serving localized transmissible content based on the set of locality identifiers.

2. A system according to claim 1, wherein the networked site comprises a Web page.

3. A system according to claim 1, wherein the set of locality identifiers comprises at least one of a geographic area name, a telephone number and address information.

4. A system according to claim 3, wherein the set of locality identifiers comprises address information, and the address information comprises a postal ZIP code.

5. A system according to claim 1, wherein the set of locality identifiers comprises a set of geographic categorizations based on a networked site identifier.

6. A system according to claim 1, wherein the set of locality identifiers comprises a set of stored user behaviors.

7. A system according to claim 1, wherein the selectable content server communicates with a content database to retrieve the localized transmissible content.

8. A system according to claim 7, wherein the content database comprises an ad table.

9. A system according to claim 1, wherein the localized transmissible content is transmitted to a client.

10. A system according to claim 9, wherein the localized transmissible content is displayed via a browser on the client.

11. A method for generating localized content for insertion into networked site content, comprising:
receiving a set of locality identifiers related to a location associated with a networked site; and
serving localized transmissible content based on the set of locality identifiers.

12. A method according to claim 11, wherein the networked site comprises a Web page.

13. A method according to claim 11, wherein the set of locality identifiers comprises at least one of a geographic area name, a telephone number and address information.

14. A method according to claim 13, wherein the set of locality identifiers comprises address information, and the address information comprises a postal ZIP code.

15. A method according to claim 11, wherein the set of locality identifiers comprises a set of geographic categorizations based on a networked site identifier.

16. A method according to claim 11, wherein the set of locality identifiers comprises a set of stored user behaviors.

17. A method according to claim 11, further comprising communicating with a content database to retrieve the localized transmissible content.

18. A method according to claim 17, wherein the content database comprises an ad table.

19. A method according to claim 11, further comprising transmitting the localized transmissible content to a client.

20. A method according to claim 19, further comprising displaying the localized transmissible content via a browser on the client.

21. A localized transmissible content object, the localized transmissible content object being generating for insertion into networked site content according to a method of:
receiving a set of locality identifiers related to a location associated with a networked site; and
serving localized transmissible content based on the set of locality identifiers.

22. A localized transmissible content object according to claim 21, wherein the networked site comprises a Web page.

23. A localized transmissible content object according to claim 21, wherein the set of locality identifiers comprises at least one of a geographic area name, a telephone number and address information.

24. A localized transmissible content object according to claim 23, wherein the set of locality identifiers comprises address information, and the address information comprises a postal ZIP code.

25. A localized transmissible content object according to claim 21, wherein the set of locality identifiers comprises a set of geographic categorizations based on a networked site identifier.

26. A localized transmissible content object according to claim 21, wherein the set of locality identifiers comprises a set of stored user behaviors.

27. A localized transmissible content object according to claim 21, wherein the method further comprises communicating with a content database to retrieve the localized transmissible content.

28. A localized transmissible content object according to claim 27, wherein the content database comprises an ad table.

29. A localized transmissible content object according to claim 21, wherein the method further comprises transmitting the localized transmissible content to a client.

30. A localized transmissible content object according to claim 29, wherein the method further comprises displaying the localized transmissible content via a browser on the client.
